(19) United States
(12) Patent Application Publication
(10) Pub. No.: US 2005/0224370 A1
(43) Pub. Date: Oct. 13, 2005

(54) Electrochemical deposition analysis system including high-stability electrode

(76) Inventors: Jun Liu, Brookfield, CT (US); Mackenzie King, Southbury, CT (US)

Correspondence Address: ATMI, INC., 7 COMMERCE DRIVE, DANBURY, CT, 06810, US

(21) Appl. No.: 10/819,765

(22) Filed: Apr. 7, 2004

(51) Int. Cl. G01N 27/26

(52) U.S. Cl. 205/794; 204/416

(57) ABSTRACT

A system and method for determining concentration of one or more components of interest in a copper electroplating solution, involving repetitive electroplating and stripping of copper, in which a ruthenium electrode is employed as a substrate for such electroplating and stripping steps. The concentration determination may be carried out by pulsed cyclic galvanostatic analysis (PCGA) or other methodology, to determine levels or accelerator and/or suppressor components of the plating bath chemistry.

### BACKGROUND OF THE INVENTION

### FIELD OF THE INVENTION

This invention relates generally to electrochemical deposition involving monitoring of additives in metal plating baths, and to a system for carrying out analysis of additives in metal plating baths, incorporating an electrode of highly robust character.

### BACKGROUND OF THE INVENTION

In the practice of copper interconnect technology in semiconductor manufacturing, electrochemical deposition is widely employed for forming interconnect structures on microelectronic substrates. The Damascene process, for example, uses physical vapor deposition to deposit a seed layer of copper on a barrier layer, followed by electrochemical deposition (ECD) of copper.

In the electrochemical deposition operation, organic additives as well as inorganic additives are employed in the plating solution of the bath in which the metal deposition is carried out. The ECD process is sensitive of concentration of both organic and inorganic components, since these components can vary considerably as they are consumed during the life of the bath. It therefore is necessary to conduct real-time monitoring and replenishment of all major bath components to ensure optimal process efficiency and yield of the semiconductor product incorporating the electrodeposited copper.

Inorganic components of the copper ECD bath include copper, sulfuric acid and chloride species, which may be measured through potentiometric analysis. Organic additives are added to the ECD bath to control uniformity of the film thickness across the wafer surface. The concentration of organic additives can be measured by cyclic voltammetry or impedence methods, or by pulsed cyclic galvanostatic analysis (PCGA), which mimics the plating conditions occurring on the wafer surface. PCGA employs a double pulse for nucleation and subsequent film growth on the electrode, in performing abbreviated electrolysis sequences and using analytical sensors to measure the ease of metal deposition. Through chemical masking and monitoring of the plating potential, additive concentrations can be determined.

A chemical analysis system of the above type, utilizing potentiometric analysis for monitoring of inorganic components of the ECD bath and PCGA analysis for monitoring of organic components, is commercially available from ATMI, Inc. (Danbury, Conn., USA) under the trademark CuChem.

In the practice of the PCGA method, a platinum electrode is utilized on which copper is cyclically plated, in a process sequence of cleaning, equilibration, plating and stripping steps.

The PCGA process is more fully described in U.S. Pat. No. 6,280,602 issued Aug. 28, 2001 to Peter M. Robertson for “Method and Apparatus for Determination of Additives in Metal Plating Baths,” the disclosure of which hereby is incorporated herein by reference for all purposes.

As disclosed in U.S. Pat. No. 6,280,602, the PCGA process is carried out to determine concentrations of organic additives such as suppressor and accelerator components in copper electroplating baths, by measuring the plating charge or stripping (de-plating) charge, e.g., for electroplating deposition of copper directly onto a test electrode via current supplied to a counter electrode in a plating step, and removal of previously plated copper in a stripping step. The charge is typically obtained by measuring the plating or stripping current while holding the voltage constant, and integrating to obtain the charge. Generally, the test electrode is cyclically plated and de-plated (stripped of the previously deposited copper) multiple times for each quantity measured.

Each plating/measurement cycle comprises the following steps:
a cleaning step, in which the test electrode surface is thoroughly cleaned electrochemically or chemically using an acid bath, followed by flushing with water or the acid bath;
an equilibration step (optional), in which the test electrode and a reference electrode are exposed to the plating electrolyte and allowed to reach an equilibrium state;
a plating step, in which copper is electroplated onto the test electrode either at constant potential or during a potential sweep and the current between the test and counter electrodes is monitored and recorded; and
a stripping step, in which the copper previously deposited is removed, such as by reversal of the plating current flow and/or exposure to an acid bath, involving change of the potential between the test and counter electrodes stepwise or in a sweep in the reverse direction, with the current between the test and counter electrodes being monitored for integration thereof to determine the stripping charge.

A problem with the traditional PCGA method of measuring organic additives such as suppressor, accelerator and leveler components of a copper plating bath is that the test electrode in extended service operation tends to deteriorate. Such deterioration may occur through a variety of degradative mechanisms. Deterioration may take place as a result of alloying of the electrode material with other materials (e.g., copper), pitting, and organic contamination. Organic contamination can occur by surface tension effects or by electrodeposition of an electroactive material that becomes irreversibly bound, so that the plating surface on the platinum electrode becomes progressively less suitable for plating and stripping steps during the course of extended operation. As a result, the current densities can vary, shifting plating potentials so that determinations of organic additive concentrations are not sufficiently accurate. These circumstances prevent the achievement of high-precision control necessary for high-volume manufacturing operations of next generation semiconductors, in which reliable metrology is critically important.

### SUMMARY OF THE INVENTION

The present invention relates generally to systems and methods for determining concentration of one or more components of interest in a copper electroplating solution, involving electroplating and stripping of copper, in which a ruthenium electrode is employed as a substrate for such electroplating and stripping of copper. The concentration determination may be carried out by pulsed cyclic galvanostatic analysis (PCGA) or other methodology, to determine levels of component(s) of interest, such as accelerator and/or suppressor components of copper plating baths.

The invention contemplates plating bath analysis for ECD operations, which achieves high accuracy of determining organic additive concentrations, by using an ECD analysis system including a robust electrode.

In one aspect, the invention relates to system for determining concentrations of organic components in plating compositions for electrochemical deposition of copper. The system includes a measurement chamber having disposed therein a ruthenium electrode having a plating surface on which copper is depositable by electroplating and from which deposited copper is strippable, in respective deposition and stripping steps of an operational cycle of the system when the measurement chamber contains an electrolyte solution. The system also includes electrical circuitry operatively coupled with the ruthenium electrode and arranged for conducting said operational cycle of the system.

In another aspect, the invention relates to a method of determining concentrations of organic components in plating compositions for electrochemical deposition of copper. The method includes the steps of:
providing a system including a measurement chamber having disposed therein a ruthenium electrode having a plating surface on which copper is depositable by electroplating and from which deposited copper is strippable, in respective deposition and stripping steps of an operational cycle of the system when the measurement chamber contains an electrolyte solution, and electrical circuitry operatively coupled with the ruthenium electrode and arranged for conducting such operational cycle of the system;
introducing electrolyte solution and plating composition components into the measurement chamber as required for such operational cycle; and
actuating the electrical circuitry to conduct the operational cycle.

A further aspect of the invention relates to a method of plating and stripping copper to determine concentration of a component of interest in a copper electroplating solution, in which a ruthenium electrode is used as a copper deposition and stripping substrate.

Yet another aspect of the invention relates to a method of maintaining stable operation in a system for determining concentration of one or more components of interest in a copper electroplating solution, involving repetitive electroplating and stripping of copper, in which a ruthenium electrode is used as a substrate for the electroplating and stripping of copper.

Other aspects, features and embodiments of the invention will be more fully apparent from the ensuing disclosure and appended claims.

### BRIEF DESCRIPTION OF THE DRAWINGS

FIG. 1 is a schematic representation of an ECD monitoring system according to the present invention according to one embodiment thereof.

FIG. 2 is a cyclic voltammogram (CV) for platinum plating with copper in VMS medium, wherein the current, in amperes, is depicted as a function of potential (voltage against Ag/AgCl).

FIG. 3 is a cyclic voltammogram (CV) for ruthenium plating with copper in VMS medium, wherein the current, in amperes, is depicted as a function of potential (voltage against Ag/AgCl).

FIG. 4 is a cyclic voltammogram (CV) for iridium plating with copper in VMS medium, wherein the current, in amperes, is depicted as a function of potential (voltage against Ag/AgCl).

### DETAILED DESCRIPTION AND PREFERRED EMBODIMENTS THEREOF

The present invention relates to systems and methods for determination of concentration of additives in metal plating baths used in ECD operations, which utilize a ruthenium electrode for plating and stripping of the metal deposited in the ECD process, to determine such concentrations.

As used herein, the term “ruthenium electrode” means an electrode having a ruthenium plating surface. The plating surface can be formed of ruthenium alone, or alternatively the plating surface may comprise Ru-based alloy compositions wherein the Ru content is at least 80% by weight, based on the total weight of the alloy composition. The Ru content in alternative embodiments can variously be at least 90% by weight, at least 95% by weight, or at least 98% by weight, based on the total weight of the alloy material. As used herein, the term “ruthenium plating surface” in reference to an electrode is intended to be broadly construed to encompass surfaces of ruthenium per se as well as surfaces formed of such high Ru-content alloys. The ruthenium electrode can be clad with ruthenium or a high Ru-content alloy, as hereinafter more fully described, but preferably the electrode is fabricated of ruthenium per se (substantially pure ruthenium, with impurity concentration not exceeding 1% by weight, based on the total weight of the material), or a high-Ru content alloy as described above.

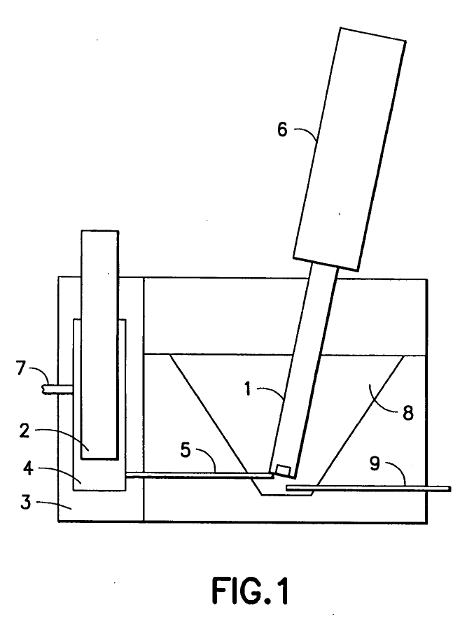

The apparatus of the present invention can be configured in one illustrative embodiment with a reference electrode housed in a reference chamber and continuously immersed in a base copper plating electrolyte solution. The apparatus includes a test electrode upon which Cu is deposited and removed in each plating/measurement cycle, disposed within a measurement chamber wherein various solutions containing additives are introduced to the base copper plating electrolyte solution, and wherein a plating current source electrode is deployed. A capillary tube in such embodiment interconnects the reference chamber and the mixing chamber in unidirectional fluid flow relationship, for introducing fresh base copper plating electrolyte solution into the measurement chamber for each plating/measurement cycle, wherein the measurement chamber end of the capillary tube is disposed in close physical proximity to the plating surface of the test electrode. The apparatus in such embodiment employs electronic circuitry that is constructed and arranged for coupling the respective electrodes and enabling concentrations of plating bath additives to be determined. Such electronic circuitry includes driving electronics operationally coupled to the test and plating current source electrodes and measurement electronics operationally coupled to the reference electrode and the test electrode. A plating bath additives analysis system of such type is shown in FIG. 1 hereof.

Referring to FIG. 1, reference electrode 2 is disposed in reference chamber 3, and continuously immersed in base copper plating electrolyte solution 4. Base solution 4 is injected into reference chamber 3 through fluid flow inlet 7, and flows into measuring chamber 8 via capillary tube 5. Additional solutions containing additives (sample solution and calibration solution(s)) are introduced into the measuring chamber (through means not depicted in FIG. 1) and thereby mixed with the base copper plating electrolyte solution introduced therein through capillary tube 5. Fluid pressure differential, and/or fluid flow valves prevent the propagation of mixed electrolyte solution from measuring chamber 8 to reference chamber 3. Thus, reference electrode 2 is continuously, exclusively immersed in base copper plating electrolyte solution 4.

The measuring chamber end of capillary tube 5 is disposed in close proximity to the plating surface of test electrode 1, preferably within a few mm. This close spatial relationship prevents air bubble formation on the plating surface of test electrode 1, and reduces or eliminates the effect of potential difference (IR drop) in the electrolyte. Plating current source electrode 9 is electrically and operatively coupled to test electrode 1 through a suitable, reversible, controllable current source (not shown).

Test electrode 1 in accordance with the present invention is a ruthenium electrode. Test electrode 1 can be mechanically and electrically coupled to rotational driver 6, or driver 6 and electrode 1 may be combined in a unitary rotating disc electrode, as is known in the art.

Alternatively, test electrode 1 can be an ultra-micro electrode with diameter less than 50 microns and preferably less than 10 microns where mixing of the electrolyte mixture within measurement chamber 8, e.g., by convection and/or externally induced movement of fluid, is not necessarily required. Where mixing of the electrolyte fluid is required, a small-scale mixer, ultrasonic vibrator, mechanical vibrator, propeller, pressure differential fluid pump, static mixer, gas sparger, magnetic stirrer, fluid ejector, or fluid eductor may be deployed in, or in connection with, the measurement chamber 8, to effect hydrodynamic movement of the fluid with respect to the test electrode.

In all embodiments, test electrode 1 is preferably tilted at an angle from vertical, to prevent the collection and retention of air bubbles on its surface. Suitable means (not shown in FIG. 1) for measuring electrical potential between the test electrode and the reference electrode are employed.

Suitable means for introduction and removal of electrolyte solutions, acid bath and rinse water are employed in the ECD analysis system, as well as suitable means for purging measurement chamber 8. These ancillary functions are easily provided by means well known in the art, and are not shown in FIG. 1 or discussed at length in the present disclosure.

The organic additive concentration determination in the analysis system of the present invention may be carried out by an adapted Pulsed Cyclic Galvanostatic Analysis (PCGA) method, involving the performance of multiple plating/measurement cycles in mixed electrolyte solutions containing various known and unknown concentrations of additives. In each plating/measurement cycle, the test electrode and measuring chamber are first thoroughly cleaned, e.g., electrolytically in an acid bath followed by a water and/or forced air flush. Base electrolyte solution is then introduced into the measuring chamber from the reference chamber, mixed with other electrolytes (containing additives), and the test electrode allowed to equilibrate. Cu is then deposited onto a plating surface on the test electrode by electroplating in the mixed electrolyte solution, at a known or constant current density. The deposited Cu is then stripped from the test electrode by reverse biasing the electroplating circuit and/or by chemical stripping. Measurements of electrical potential between the test and reference electrodes are recorded throughout the cycle.

A single plating/measurement cycle of the PCGA technique performed with the apparatus of the present invention comprises the following steps:
1) The test electrode and measurement chamber are cleaned by an acid wash followed by a water flush and/or a forced air purge.
2) Fresh base copper plating electrolyte solution is introduced to the measurement chamber from the reference chamber through the capillary tube.
3) Solutions of copper plating electrolyte variously “doped” with organic additives are introduced to, and intermixed with, the base copper plating electrolyte solution in the measurement chamber.
4) Following equilibration of the test electrode, Cu is deposited via electroplating onto the test electrode at a known or constant current density for a set time sufficient to ensure stability, and the electrical potential between the test electrode and the reference electrode is measured and recorded (the “decisive potential”). The reference electrode, being continuously exclusively immersed in fresh base copper plating electrolyte solution, requires no equilibration, hence significantly reducing the overall cycle time.
5) Following the plating step, with zero current flow in the electroplating circuit, the electrical potential between the test electrode and reference electrode is again measured and recorded (the “equilibrium potential”). The over-potential is determined by subtracting equilibrium potential from the decisive potential.
6) The deposited Cu is stripped from the test electrode by reversed biasing the plating circuit, and/or the introduction of chemical stripping agents into the measurement chamber. The electrical potential between the test electrode and reference electrode is again measured and recorded (the “stripping potential”).

Concentrations of organic additives in copper plating electrolyte baths can be calculated indirectly, according to the multiple-plating/measurement cycle of the PCGA technique, by the following steps, wherein each step involving a plating/measuring cycle is performed multiple times (e.g., four times) and the results averaged, to eliminate random errors:
1) preparing a base copper plating electrolyte solution (“basis solution”) which contains all of the components of the plating solution to be measured (the “sample”), except the component of interest;
2) preparing a plurality of calibration solutions each of which contains the component of interest in a known concentration (“standard addition”) in excess of that which would be expected in the sample;
3) performing a plating/measuring cycle in the basis solution and optionally adding a known volume of additive (suppressor) in order to eliminate non-linear response behavior, and measuring the electrical potential between the test electrode and reference electrode at a set time after beginning the plating phase (the “decisive potential”), and again following the plating step, with zero current flow in the electroplating circuit (the “equilibrium potential”), and calculating the over-potential by subtracting equilibrium potential from the decisive potential.
4) adding a measured amount of the sample solution to a known volume of the basis solution, performing a plating/measuring cycle in the mixed solution, and measuring the decisive potential and the over-potential of the mixed solution.
5) adding a measured amount of the first calibration solution (containing the first standard addition) to the same volume of fresh basis solution, performing a plating/measuring cycle in the mixed solution, and measuring the decisive potential and the over-potential of the mixed solution;
6) repeating step 5 for each calibration solution, containing each standard addition; and
7) plotting the reciprocals of the decisive potentials and/or the over-potentials measured on a reciprocal concentration scale, and performing a linear extrapolation back to the basis measurement to obtain the negative reciprocal of the sample concentration of the component of interest.

The present invention is based on the discovery that ruthenium electrodes can be advantageously employed as platable/strippable electrodes in ECD analytical systems of the type illustratively described above, to achieve a highly robust electrode arrangement for ECD analysis and monitoring. The non-obviousness of the invention relates to the fact that there is no predictive basis from elementary principles of electrochemical deposition to suggest that ruthenium would evidence marked superiority as a material of construction for platable/strippable electrodes in electrolytic media of the types employed for ECD monitoring operations.

Indeed, the ubiquity and proven character of platinum electrodes in electrolytic media would on its face suggest that a more advantageous approach would be to recondition the surface of the platinum electrode material between monitoring operations, and/or to utilize corrosion inhibitors, in order to overcome the plating surface issues of deterioration and time-varying output signal from platinum electrodes that have been associated with the employment of platinum electrodes in ECD monitoring systems of the type described hereinabove.

Surprisingly, however, the use of ruthenium as a material of construction for test electrodes used in real-time ECD monitoring systems has been shown to provide test electrodes having a marked superiority over platinum electrodes of the prior art. Specifically, ruthenium electrodes are characterized by an unexpected reduction in corrosion susceptibility, in relation to corresponding platinum electrodes, as well as underpotential copper plating behavior that reflects (in hysteretic profiles in cyclic voltammetry determinations) effective monolayer formation of copper on the electrode prior to bulk growth. By effective monolayer formation of copper, the film growth of the deposited metal is facilitated and the resulting plating and stripping operations provide accurate and stable sensing in the use of the ruthenium electrode.

The superiority and utility of ruthenium as a material for construction for test electrodes in ECD analysis systems is shown more fully hereinafter by voltammometric, open circuit potential and static etch characterizations of respective electrode materials.

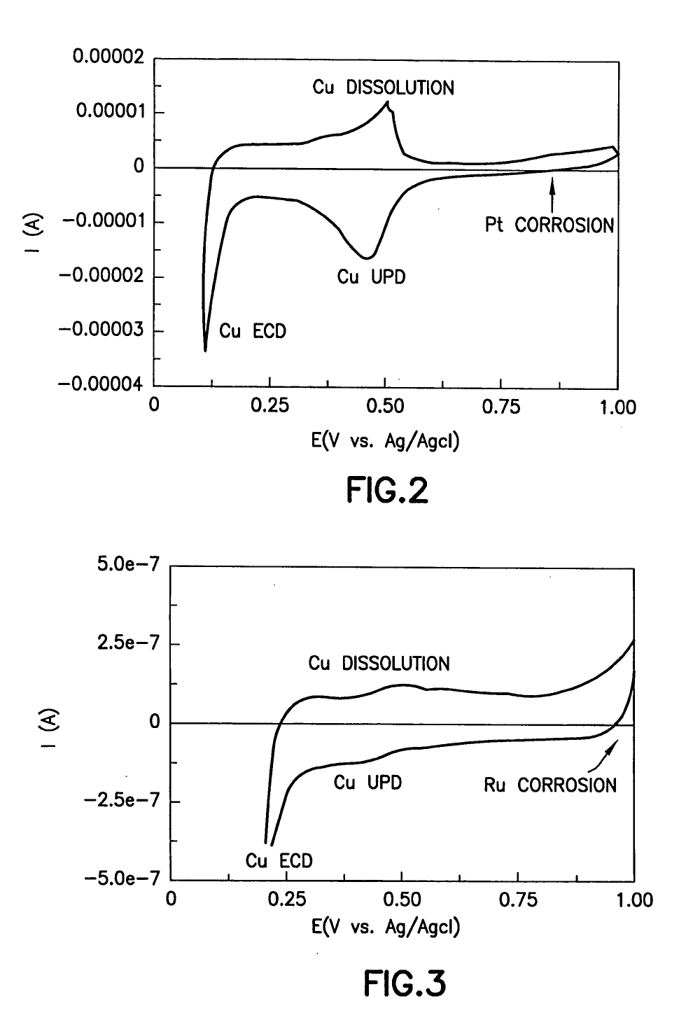

Cyclic voltammograms for deposition of copper are shown in FIGS. 2-4. Copper was electrodeposited on each of the respective test electrode samples in a system of the type shown in FIG. 1, after the test electrode was cleaned in 0.1 M sulfuric acid solution. The platinum test electrode was scanned in VMS solution, starting from the open circuit potential value down to −0.4V. It was then scanned to the maximum of +1.7V, and then back to the original open circuit potential value, to yield the cyclic voltammogram of FIG. 2.

In such voltammetry determinations, the scan rates can vary from 100 mV/s up to 2V/s and typically 10-36 cycles are run per analysis.

To elucidate the region of interest, the ruthenium electrode correspondingly was scanned over a truncated region to enhance signal-to-noise, from the open circuit potential to 0.22 V and then to the maximum of +1.0 V and finally back to the original open circuit valve to generate the cyclic voltammogram of FIG. 3.

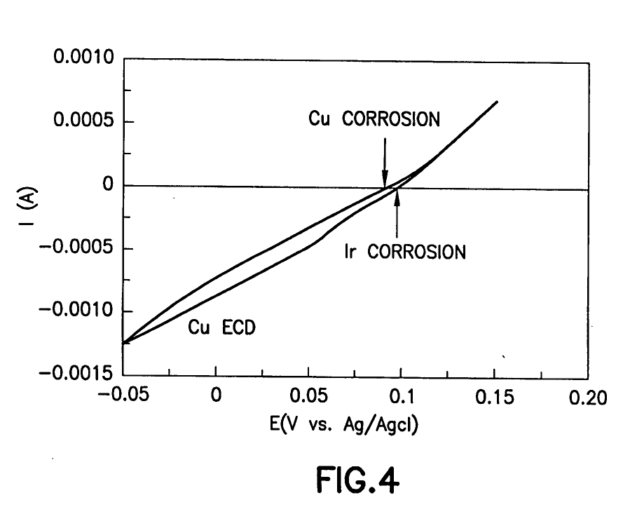

The iridium electrode was scanned down from the open circuit potential to a negative maximum of −0.05 V, then to a positive maximum of +0.15 V, and finally back to the open circuit potential to complete the cyclic voltammogram of FIG. 4.

Characterization of the metals was carried out using CVD-deposited metals on silicon wafers. The spot size was approximately 1 cm in diameter. Silicon wafer-supported metal films were used for the analysis, to avoid analytical problems with small currents, small electrode size, and measurement capability of available instrumentation. The 1 cm spot size was used based on analysis of physical properties of platinum, for characterization samples of 1 cm diameter and 10 microns diameter. Such analytical assessment of platinum showed that physical properties of the metal did not change over this range of sizes of characterization samples, thereby justifying the use of 1 cm spot size samples of iridium and ruthenium for characterization studies. The virgin make-up solution (VMS) solution used in the characterization studies had the following formulation: 157 g/L CuSO₄5 H₂O, 50 ppm HCl, 10 g/L H₂SO₄, and balance H₂O.

In the ECD of copper, underpotential deposition (UPD) of copper occurs at a potential above the copper plating potential, so that a monolayer of copper is formed prior to the three-dimensional growth of bulk copper. In the cyclic voltammograms for copper deposition of copper on each of the Pt, Ru and Ir test electrodes, UPD behavior was evidenced on the Pt and Ru test electrodes.

FIG. 2 is the cyclic voltammogram (CV) for copper plating on platinum in the VMS medium, wherein the plating current, in amperes, is depicted as a function of potential (voltage against Ag/AgCl). This cyclic voltammogram for the Pt/Cu system in VMS medium clearly shows a UPD peak for copper deposition in the cathodic range.

FIG. 3 is the cyclic voltammogram (CV) for copper plating on ruthenium in the VMS medium, wherein the plating current, in amperes, is depicted as a function of potential (voltage against Ag/AgCl). For the Ru/Cu system in VMS medium, the UPD peak is observed at lower voltage scan rate.

FIG. 4 is the cyclic voltammogram (CV) for copper plating on iridium in the VMS medium, wherein the plating current, in amperes, is depicted as a function of potential (voltage against Ag/AgCl). The Ir/Cu system in VMS medium does not display any UPD feature.

Table I below shows corrosion data for platinum, iridium and ruthenium electrode samples in virgin make-up solution (VMS), including open circuit potential (voltage measured against Ag/AgCl as the reference electrode) and static etch rate, in Angstroms per minute.

TABLE I
Corrosion Potential for Pt, Ru and Ir in VMS Solution

| Parameter | Pt | Ru | Ir |
|---|---|---|---|
| Open Circuit | 0.869 | 0.959 | 0.0964 |
| Potential (V vs. | | | |
| Ag/AgCl) | | | |
| Static Etch Rate | 6.05 | 0.81 | 4276 |
| (A/min) | | | |

The foregoing results show that Ru has the lowest static etch rate and the highest open circuit potential, in relation to Pt and Ir. The open circuit potential of ruthenium is an order of magnitude larger than that of iridium, and is more than 10% higher than the open circuit potential of platinum. The static etch rate of ruthenium in the VMS medium is only 13.4% of the etch rate of platinum and 0.02% of the etch rate of iridium.

This empirically demonstrated superiority of ruthenium over platinum, which is the standard prior art electrode material of construction, and over iridium, which is frequently alloyed with platinum to improve its properties, evidences the utility of ruthenium for test electrode fabrication. The substantially reduced corrosivity of ruthenium in the electrolytic medium reflects the stability of such material in electrode fabrication, and the stability of the output signal that is derived from such electrode in the ECD monitoring system. Corrosion increases the surface roughness of the test electrode, and changes the output derived from the progressively corrosion-roughened surface.

Ruthenium thus presents a material that is uniquely suited for replacement of platinum in electrodes used for plating/stripping operations in real-time monitoring of ECD plating baths by PCGA.

The ruthenium test electrode in the ECD plating bath analysis system of the invention, in one preferred aspect of the invention, has a microelectrode conformation, with a diameter that may for example be in a range of from about 1 μm to about 200 μm, more preferably in a range of from about 10 μm to about 150 μm, and most preferably in a range of from about 25 μm to about 125 μm, and a length to diameter ratio that may for example be in a range of from about 0.5 to about 10, or even higher length to diameter values, as may be appropriate in a given application. The electrode is formed with a plating surface that can be formed of ruthenium alone, or alternatively the plating surface may comprise Ru-based alloy compositions wherein the Ru content is at least 80% by weight, based on the total weight of the alloy composition. Potentially useful alloying metals for use with Ru to form such high Ru-content alloys include, without limitation, platinum, palladium, nickel, vanadium, aluminum, iridium, chromium, and tungsten, or other materials may be employed as alloy constituents or dopants for the ruthenium-based electrode.

The test electrode in a preferred embodiment is formed of ruthenium throughout, but Ru alternatively can be used to form a cladding on a core of other metal, such as a core of copper, aluminum, nickel, vanadium, platinum, iridium, chromium, tungsten, platinum/iridium alloy, etc., in order to provide the required ruthenium plating surface. When ruthenium is used as a cladding material for providing the ruthenium plating surface, the thickness of the ruthenium cladding can for example be on the order of from about 10 nm to about 10 μm, although it is to be recognized that larger or smaller thicknesses of ruthenium may be usefully employed in particular applications of the invention, depending on the substrate dimensions of the core body, and the monitoring operation and conditions of the test electrode in use.

As an alternative to the use of microelectrode structures, any other electrode suitable conformations can be employed in the practice of the invention. The ruthenium test electrode can be formed as a film on a substrate, as part of an electrochemical cell assembly in the monitoring system. Film thicknesses of ruthenium in such conformation can for example be on the order of from about 50 nm to about 100 μm, although it will be appreciated that greater or lesser thicknesses of ruthenium may be usefully employed in particular applications of the invention.

The invention thus contemplates the provision of a copper-platable and -strippable ruthenium electrode in an ECD monitoring system, to achieve an improvement in operating lifetime with maintenance of accuracy and stability of output from the monitoring circuitry including such electrode. The invention correspondingly provides a methodology for plating and stripping copper to determine concentration of component(s) of interest in a copper electroplating solution, e.g., by repetitive plating/stripping steps in a PCGA determination, in which the use of a ruthenium electrode as a copper deposition and stripping substrate, to achieve high efficiency operation of the analysis system without loss of signal strength and deterioration of the electroplating and stripping steps, such as are experienced in extended lifetime operation of ECD monitoring systems employing platinum electrode elements. In order to maximize stability of ruthenium electrode operation, it may be desirable to operate in a voltage regime that ensures the maintenance of the surface state of the electrode in cyclic operation. For example, the PCGA determination may be carried out in a manner that does not allow the ruthenium electrode to exceed a voltage of 0.8 volts.

While the invention has been described herein with reference to specific features, aspects, and embodiments, it will be recognized that the invention is susceptible to variations, modifications and implementation in alternative embodiments, as will suggest themselves to those of ordinary skill in the art, based on the disclosure herein. Accordingly, the invention is intended to be broadly construed and interpreted, as encompassing all such variations, modifications and alternative embodiments, as being within the spirit and scope of the invention as hereinafter claimed.

1. A system for determining concentrations of organic components in plating compositions for electrochemical deposition of copper, said system comprising a measurement chamber having disposed therein a ruthenium electrode having a plating surface on which copper is depositable by electroplating and from which deposited copper is strippable, in respective deposition and stripping steps of an operational cycle of said system when the measurement chamber contains an electrolyte solution, and electrical circuitry operatively coupled with the ruthenium electrode and arranged for conducting said operational cycle of the system.

2. The system of claim 1, wherein said electrical circuitry comprises an electroplating current source electrode in said measurement chamber.

3. The system of claim 2, wherein said electrical circuitry further comprises a reference electrode positioned in a reference chamber arranged to receive a base copper plating solution.

4. The system of claim 3, wherein said electrical circuitry comprises driving electronics electrically and operationally coupled between the ruthenium electrode and the electroplating current source electrode, whereby copper is selectively depositable on the ruthenium electrode at a constant or known current density when the measurement chamber contains a copper plating solution as the electrolyte solution therein.

5. The system of claim 4, wherein said electrical circuitry comprises electrical potential measuring circuitry electrically and operatively coupled between the ruthenium electrode and the reference electrode, whereby electrical potential is measured and recorded.

6. The system of claim 3, wherein said electrical circuitry is constructed and arranged to carry out PCGA determinations of plating solution additives.

7. The system of claim 6, wherein said additives are selected from the group consisting of electrodeposition accelerators, suppressors and levelers.

8. The system of claim 1, wherein the ruthenium electrode comprises substantially pure ruthenium.

9. The system of claim 1, wherein the ruthenium electrode is formed of a ruthenium alloy containing at least 80% ruthenium.

10. The system of claim 1, wherein the ruthenium electrode has a microelectrode conformation, with a diameter in a range of from about 1 μm to about 200 μm.

11. A method of determining concentrations of organic components in plating compositions for electrochemical deposition of copper, said method comprising:
providing a system including a measurement chamber having disposed therein a ruthenium electrode having a plating surface on which copper is depositable by electroplating and from which deposited copper is strippable, in respective deposition and stripping steps of an operational cycle of said system when the measurement chamber contains an electrolyte solution, and electrical circuitry operatively coupled with the ruthenium electrode and arranged for conducting said operational cycle of the system;
introducing electrolyte solution and plating composition components into said measurement chamber as required for said operational cycle; and
actuating said electrical circuitry to conduct said operational cycle.

12. The method of claim 11, wherein the operational cycle includes repetitive plating and stripping steps.

13. The method of claim 11, wherein the operational cycle includes PCGA operation.

14. The method of claim 13, wherein said PCGA operation determines concentration of plating bath additives.

15. The method of claim 14, wherein said additives are selected from the group consisting of electrodeposition accelerators, suppressors and levelers.

16. The method of claim 14, wherein said additives includes accelerator and suppressor additives.

17. A method of plating and stripping copper to determine concentration of a component of interest in a copper electroplating solution, said method comprising using a ruthenium electrode as a copper deposition and stripping substrate.

18. The method of claim 17, wherein copper is plated on the ruthenium electrode by electrodeposition including under-potential deposition of copper.

19. A method of maintaining stable operation in a system for determining concentration of one or more components of interest in a copper electroplating solution, involving repetitive electroplating and stripping of copper, said method comprising using a ruthenium electrode as a substrate for said electroplating and stripping of copper.

20. The method of claim 19, wherein the ruthenium electrode has a microelectrode conformation.

21. The method of claim 19, wherein the ruthenium electrode does not exceed an operating potential of 0.8 volts.
